(19) United States
(12) Patent Application Publication
(10) Pub. No.: US 2026/0222558 A1
(43) Pub. Date: Jul. 30, 2026

(54) METHOD AND APPARATUS FOR ENCODING/DECODING IMAGE AND RECORDING MEDIUM FOR STORING BITSTREAM

(71) Applicants: Hyundai Motor Company, Seoul (KR); Kia Corporation, Seoul (KR)

(72) Inventors: Jin HEO, Yongin-si Gyeonggi-do (KR); Jungah CHOI, Seoul (KR); Seung Wook PARK, Yongin-si Gyeonggi-do (KR)

(21) Appl. No.: 19/146,714

(22) PCT Filed: Feb. 23, 2024
(86) PCT No.: PCT/KR2024/002404

§ 371 Date: Jul. 9, 2025

(30) Foreign Application Priority Data
Feb. 23, 2023 (KR) 10-2023-0024295
Feb. 23, 2024 (KR) 10-2024-0026437

(51) Int. Cl. H04N 19/11; H04N 19/105; H04N 19/176

(52) U.S. Cl. CPC H04N 19/11; H04N 19/105; H04N 19/176

(57) ABSTRACT

An image encoding/decoding method and apparatus, a recording medium for storing a bitstream and a transmission method are provided. The image decoding method may comprise determining an intra prediction mode of a current block, deriving an omni-directional reference sample, and performing intra prediction based on the omni-directional reference sample and the intra prediction mode. The omni-directional reference sample includes a first reference sample located at any one of a top, left, and top left of the current block and a second reference sample located at any one of a bottom, right, and bottom right of the current block.

### TECHNICAL FIELD

The present invention relates to a method and apparatus for encoding/decoding an image and a recording medium storing a bitstream. Specifically, the present invention relates to a method and apparatus for encoding/decoding an image based on reference sample derivation for intra prediction and an intra prediction method using the same and a recording medium storing a bitstream.

### BACKGROUND ART

Recently, the demand for high-resolution, high-quality images such as ultra-high definition (UHD) images is increasing in various application fields. As image data becomes higher in resolution and quality, the amount of data increases relatively compared to existing image data. Therefore, when transmitting image data using media such as existing wired and wireless broadband lines or storing image data using existing storage media, the transmission and storage costs increase. In order to solve these problems that occur as image data becomes higher in resolution and quality, high-efficiency image encoding/decoding technology for images with higher resolution and quality is required.

In existing intra prediction methods, reference samples located on the left, top, or top left of a current block were used for intra prediction. Such existing intra prediction methods have a problem in that prediction accuracy decreases as samples are farther away from the reference samples located on the left, top, or top left, such as samples located in the bottom right area of the current block.

### DISCLOSURE

### Technical Problem

An object of the present invention is to provide an image encoding/decoding method and apparatus with improved encoding/decoding efficiency.

In addition, an object of the present invention is to provide a recording medium for storing a bitstream generated by an image decoding method or apparatus according to the present invention.

In addition, an object of the present invention is to provide improved reference sample derivation and an intra prediction method using the same to solve the problems of the intra prediction method.

### Technical Solution

An image decoding method according to an embodiment of the present invention may comprise determining an intra prediction mode of a current block, deriving an omni-directional reference sample, and performing intra prediction based on the omni-directional reference sample and the intra prediction mode. The omni-directional reference sample includes a first reference sample located at any one of a top, left, and top left of the current block and a second reference sample located at any one of a bottom, right, and bottom right of the current block.

In the image decoding method, the first reference sample may be derived from a reconstructed area.

In the image decoding method, the second reference sample is derived based on a neighboring sample of a matching block searched by performing template matching.

In the image decoding method, the second reference sample is derived based on a weighted sum of neighboring blocks of a plurality of matching blocks searched by performing multiple template matching.

In the image decoding method, the second reference sample is derived based on a neighboring sample of a matching block in a current picture indicated by motion information of the current block.

In the image decoding method, the second reference sample is derived based on a neural network model that receives a sample of a reconstructed area neighboring the current block as input.

In the image decoding method, the intra prediction mode includes an omnidirectionally extended directional mode.

In the image decoding method, the intra prediction is performed by a weighted sum of a first prediction sample generated using the first reference sample according to the intra prediction mode and a second prediction sample generated using a second reference sample corresponding to the first reference sample.

An image encoding method according to an embodiment of the present invention may comprise determining an intra prediction mode of a current block, deriving an omni-directional reference sample and performing intra prediction based on the omni-directional reference sample and the intra prediction mode. The omni-directional reference sample may include a first reference sample located at any one of a top, left, and top left of the current block and a second reference sample located at any one of a bottom, right, and bottom right of the current block.

A non-transitory computer-readable recording medium according to an embodiment of the present invention may store a bitstream generated by an image encoding method. The image encoding method may comprise determining an intra prediction mode of a current block, deriving an omni-directional reference sample and performing intra prediction based on the omni-directional reference sample and the intra prediction mode. The omni-directional reference sample may include a first reference sample located at any one of a top, left, and top left of the current block and a second reference sample located at any one of a bottom, right, and bottom right of the current block.

A transmission method according to an embodiment of the present invention may transmit a bitstream generated by an image encoding method and may comprise transmitting the bitstream. The image encoding method may comprise determining an intra prediction mode of a current block, deriving an omni-directional reference sample and performing intra prediction based on the omni-directional reference sample and the intra prediction mode. The omni-directional reference sample may include a first reference sample located at any one of a top, left, and top left of the current block and a second reference sample located at any one of a bottom, right, and bottom right of the current block.

The features briefly summarized above with respect to the present disclosure are merely exemplary aspects of the detailed description below of the present disclosure, and do not limit the scope of the present disclosure.

### Advantageous Effects

According to the present invention, it is possible to provide an image encoding/decoding method and apparatus with improved encoding/decoding efficiency.

In addition, according to the present invention, it is possible to provide improved reference sample derivation and an intra prediction method using the same.

In addition, according to the present invention, it is possible to improve intra prediction accuracy.

It will be appreciated by persons skilled in the art that that the effects that can be achieved through the present disclosure are not limited to what has been particularly described hereinabove and other advantages of the present disclosure will be more clearly understood from the detailed description.

### DESCRIPTION OF DRAWINGS

FIG. 1 is a block diagram showing a configuration of an encoding apparatus according to an embodiment of the present invention.

FIG. 2 is a block diagram showing a configuration of a decoding apparatus according to an embodiment of the present invention.

FIG. 3 is a diagram schematically showing a video coding system to which the present invention is applicable.

FIGS. 4 to 6 are diagrams showing intra prediction modes used in a uni-directional intra prediction method using a first reference sample of a current block.

FIG. 7 is a diagram for explaining an omni-directional reference sample for intra prediction according to an embodiment of the present invention.

FIG. 8 is a diagram for explaining a neural network-based reference sample derivation method according to an embodiment of the present invention.

FIGS. 9 to 10 are diagrams for explaining a template matching-based reference sample derivation method according to an embodiment of the present invention.

FIG. 11 is a diagram for explaining a motion information-based reference sample derivation method according to an embodiment of the present invention.

FIG. 12 is a diagram for explaining a plurality of reference sample lines derived using a neural network-based reference sample derivation method according to an embodiment of the present invention.

FIG. 13 is a diagram for explaining bi-directional intra prediction using omni-directional reference samples according to an embodiment of the present invention.

FIG. 14 is a diagram for explaining uni-directional intra prediction using omni-directional reference samples according to an embodiment of the present invention.

FIG. 15 is a flowchart illustrating an image decoding method according to an embodiment of the present invention.

FIG. 16 exemplary illustrates a content streaming system to which an embodiment according to the present invention is applicable.

### MODE FOR INVENTION

The present invention may have various modifications and embodiments, and specific embodiments are illustrated in the drawings and described in detail in the detailed description. However, this is not intended to limit the present invention to specific embodiments, but should be understood to include all modifications, equivalents, or substitutes included in the spirit and technical scope of the present invention. Similar reference numerals in the drawings indicate the same or similar functions throughout various aspects. The shapes and sizes of elements in the drawings may be provided by way of example for a clearer description. The detailed description of the exemplary embodiments described below refers to the accompanying drawings, which illustrate specific embodiments by way of example. These embodiments are described in sufficient detail to enable those skilled in the art to practice the embodiments. It should be understood that the various embodiments are different from each other, but are not necessarily mutually exclusive. For example, specific shapes, structures, and characteristics described herein may be implemented in other embodiments without departing from the spirit and scope of the present invention with respect to one embodiment. It should also be understood that the positions or arrangements of individual components within each disclosed embodiment may be changed without departing from the spirit and scope of the embodiment. Accordingly, the detailed description set forth below is not intended to be limiting, and the scope of the exemplary embodiments is defined only by the appended claims, along with the full scope of equivalents to which such claims are entitled, if properly described.

In the present invention, the terms first, second, etc. may be used to describe various components, but the components should not be limited by the terms. The terms are only used for the purpose of distinguishing one component from another. For example, without departing from the scope of the present invention, the first component may be referred to as the second component, and similarly, the second component may also be referred to as the first component. The term is and/or includes a combination of a plurality of related described items or any item among a plurality of related described items.

The components shown in the embodiments of the present invention are independently depicted to indicate different characteristic functions, and do not mean that each component is formed as a separate hardware or software configuration unit. That is, each component is listed and included as a separate component for convenience of explanation, and at least two of the components may be combined to form a single component, or one component may be divided into multiple components to perform a function, and embodiments in which components are integrated and embodiments in which each component is divided are also included in the scope of the present invention as long as they do not deviate from the essence of the present invention.

The terminology used in the present invention is only used to describe specific embodiments and is not intended to limit the present invention. The singular expression includes the plural expression unless the context clearly indicates otherwise. In addition, some components of the present invention are not essential components that perform essential functions in the present invention and may be optional components only for improving performance. The present invention may be implemented by including only essential components for implementing the essence of the present invention excluding components only used for improving performance, and a structure including only essential components excluding optional components only used for improving performance is also included in the scope of the present invention.

In an embodiment, the term “at least one” may mean one of a number greater than or equal to 1, such as 1, 2, 3, and 4. In an embodiment, the term “a plurality of” may mean one of a number greater than or equal to 2, such as 2, 3, and 4.

Hereinafter, embodiments of the present invention will be specifically described with reference to the drawings. In describing the embodiments of this specification, if it is determined that a detailed description of a related known configuration or function may obscure the subject matter of this specification, the detailed description will be omitted, and the same reference numerals will be used for the same components in the drawings, and repeated descriptions of the same components will be omitted.

### DESCRIPTION OF TERMS

Hereinafter, “image” may mean one picture constituting a video, and may also refer to the video itself. For example, “encoding and/or decoding of an image” may mean “encoding and/or decoding of a video,” and may also mean “encoding and/or decoding of one of images constituting the video.”

Hereinafter, “moving image” and “video” may be used with the same meaning and may be used interchangeably. In addition, a target image may be an encoding target image that is a target of encoding and/or a decoding target image that is a target of decoding. In addition, the target image may be an input image input to an encoding apparatus and may be an input image input to a decoding apparatus. Here, the target image may have the same meaning as a current image.

Hereinafter, encoder and image encoding apparatus may be used with the same meaning and may be used interchangeably.

Hereinafter, decoder and image decoding apparatus may be used with the same meaning and may be used interchangeably.

Hereinafter, “image”, “picture”, “frame” and “screen” may be used with the same meaning and may be used interchangeably.

Hereinafter, a “target block” may be an encoding target block that is a target of encoding and/or a decoding target block that is a target of decoding. In addition, the target block may be a current block that is a target of current encoding and/or decoding. For example, “target block” and “current block” may be used with the same meaning and may be used interchangeably.

Hereinafter, “block” and “unit” may be used with the same meaning and may be used interchangeably. In addition, “unit” may mean including a luma component block and a chroma component block corresponding thereto in order to distinguish it from a block. For example, a coding tree unit (CTU) may be composed of one luma component (Y) coding tree block (CTB) and two chroma component (Cb, Cr) coding tree blocks related to it.

Hereinafter, “sample”, “picture element” and “pixel” may be used with the same meaning and may be used interchangeably. Herein, a sample may represent a basic unit that constitutes a block.

Hereinafter, “inter” and “inter-screen” may be used with the same meaning and can be used interchangeably.

Hereinafter, “intra” and “in-screen” may be used with the same meaning and can be used interchangeably.

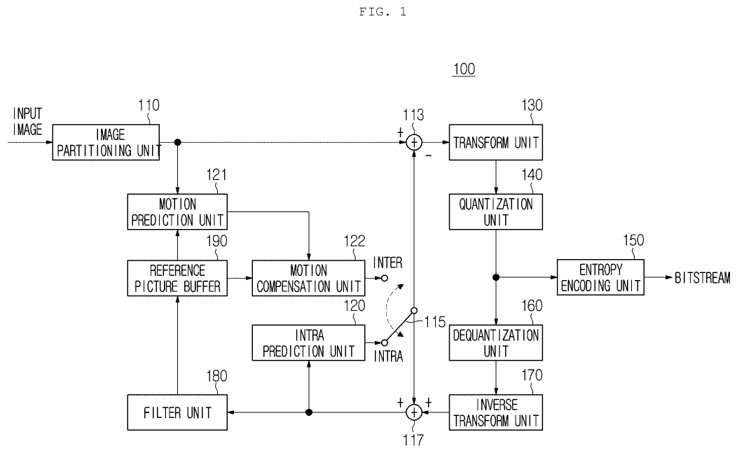

FIG. 1 is a block diagram showing a configuration of an encoding apparatus according to an embodiment of the present invention.

The encoding apparatus 100 may be an encoder, a video encoding apparatus, or an image encoding apparatus. A video may include one or more images. The encoding apparatus 100 may sequentially encode one or more images.

Referring to FIG. 1, the encoding apparatus 100 may include an image partitioning unit 110, an intra prediction unit 120, a motion prediction unit 121, a motion compensation unit 122, a switch 115, a subtractor 113, a transform unit 130, a quantization unit 140, an entropy encoding unit 150, a dequantization unit 160, an inverse transform unit 170, an adder 117, a filter unit 180 and a reference picture buffer 190.

In addition, the encoding apparatus 100 may generate a bitstream including information encoded through encoding of an input image, and output the generated bitstream. The generated bitstream may be stored in a computer-readable recording medium, or may be streamed through a wired/wireless transmission medium.

The image partitioning unit 110 may partition the input image into various forms to increase the efficiency of video encoding/decoding. That is, the input video is composed of multiple pictures, and one picture may be hierarchically partitioned and processed for compression efficiency, parallel processing, etc. For example, one picture may be partitioned into one or multiple tiles or slices, and then partitioned again into multiple CTUS (Coding Tree Units). Alternatively, one picture may first be partitioned into multiple sub-pictures defined as groups of rectangular slices, and each sub-picture may be partitioned into the tiles/slices. Here, the sub-picture may be utilized to support the function of partially independently encoding/decoding and transmitting the picture. Since multiple sub-pictures may be individually reconstructed, it has the advantage of easy editing in applications that configure multi-channel inputs into one picture. In addition, a tile may be divided horizontally to generate bricks. Here, the brick may be utilized as the basic unit of parallel processing within the picture. In addition, one CTU may be recursively partitioned into quad trees (QTs), and the terminal node of the partition may be defined as a CU (Coding Unit). The CU may be partitioned into a PU (Prediction Unit), which is a prediction unit, and a TU (Transform Unit), which is a transform unit, to perform prediction and partition. Meanwhile, the CU may be utilized as the prediction unit and/or the transform unit itself. Here, for flexible partition, each CTU may be recursively partitioned into multi-type trees (MTTs) as well as quad trees (QTs). The partition of the CTU into multi-type trees may start from the terminal node of the QT, and the MTT may be composed of a binary tree (BT) and a triple tree (TT). For example, the MTT structure may be classified into a vertical binary split mode (SPLIT BT VER), a horizontal binary split mode (SPLIT BT HOR), a vertical ternary split mode (SPLIT TT VER), and a horizontal ternary split mode (SPLIT TT HOR). In addition, a minimum block size (MinQTSize) of the quad tree of the luma block during partition may be set to 16×16, a maximum block size (MaxBtSize) of the binary tree may be set to 128×128, and a maximum block size (MaxTtSize) of the triple tree may be set to 64×64. In addition, a minimum block size (MinBtSize) of the binary tree and a minimum block size (MinTtSize) of the triple tree may be specified as 4×4, and the maximum depth (MaxMttDepth) of the multi-type tree may be specified as 4. In addition, in order to increase the encoding efficiency of the I slice, a dual tree that differently uses CTU partition structures of luma and chroma components may be applied. On the other hand, in P and B slices, the luma and chroma CTBs (Coding Tree Blocks) within the CTU may be partitioned into a single tree that shares the coding tree structure.

The encoding apparatus 100 may perform encoding on the input image in the intra mode and/or the inter mode. Alternatively, the encoding apparatus 100 may perform encoding on the input image in a third mode (e.g., IBC mode, Palette mode, etc.) other than the intra mode and the inter mode. However, if the third mode has functional characteristics similar to the intra mode or the inter mode, it may be classified as the intra mode or the inter mode for convenience of explanation. In the present invention, the third mode will be classified and described separately only when a specific description thereof is required.

When the intra mode is used as the prediction mode, the switch 115 may be switched to intra, and when the inter mode is used as the prediction mode, the switch 115 may be switched to inter. Here, the intra mode may mean an intra prediction mode, and the inter mode may mean an inter prediction mode. The encoding apparatus 100 may generate a prediction block for an input block of the input image. In addition, the encoding apparatus 100 may encode a residual block using a residual of the input block and the prediction block after the prediction block is generated. The input image may be referred to as a current image which is a current encoding target. The input block may be referred to as a current block which is a current encoding target or an encoding target block.

When a prediction mode is an intra mode, the intra prediction unit 120 may use a sample of a block that has been already encoded/decoded around a current block as a reference sample. The intra prediction unit 120 may perform spatial prediction for the current block by using the reference sample, or generate prediction samples of an input block through spatial prediction. Herein, the intra prediction may mean in-screen prediction.

As an intra prediction method, non-directional prediction modes such as DC mode and Planar mode and directional prediction modes (e.g., 65 directions) may be applied. Here, the intra prediction method may be expressed as an intra prediction mode or an in-screen prediction mode.

When a prediction mode is an inter mode, the motion prediction unit 121 may retrieve a region that best matches with an input block from a reference image in a motion prediction process, and derive a motion vector by using the retrieved region. In this case, a search region may be used as the region. The reference image may be stored in the reference picture buffer 190. Here, when encoding/decoding for the reference image is performed, it may be stored in the reference picture buffer 190.

The motion compensation unit 122 may generate a prediction block of the current block by performing motion compensation using a motion vector. Herein, inter prediction may mean inter-screen prediction or motion compensation.

When the value of the motion vector is not an integer, the motion prediction unit 121 and the motion compensation unit 122 may generate the prediction block by applying an interpolation filter to a partial region of the reference picture. In order to perform inter prediction or motion compensation, it may be determined whether the motion prediction and motion compensation mode of the prediction unit included in the coding unit is one of a skip mode, a merge mode, an advanced motion vector prediction (AMVP) mode, and an intra block copy (IBC) mode based on the coding unit and inter prediction or motion compensation may be performed according to each mode.

In addition, based on the above inter prediction method, an AFFINE mode of sub-PU based prediction, an SbTMVP (Subblock-based Temporal Motion Vector Prediction) mode, an MMVD (Merge with MVD) mode of PU-based prediction, and a GPM (Geometric Partitioning Mode) mode may be applied. In addition, in order to improve the performance of each mode, HMVP (History based MVP), PAMVP (Pairwise Average MVP), CIIP (Combined Intra/Inter Prediction), AMVR (Adaptive Motion Vector Resolution), BDOF (Bi-Directional Optical-Flow), BCW (Bi-predictive with CU Weights), LIC (Local Illumination Compensation), TM (Template Matching), OBMC (Overlapped Block Motion Compensation), etc. may be applied.

Among these, the AFFINE mode is a technology that is used in both AMVP and MERGE modes and also has high encoding efficiency. In the existing video coding standard, since MC (Motion Compensation) is performed by considering only the parallel movement of blocks, it has a disadvantage in that it cannot properly compensate for motions that occur in reality, such as zoom-in/out and rotation. To supplement this, a four-parameter affine motion model using two control point motion vectors (CPMVs) and a six-parameter affine motion model using three control point motion vectors may be used and applied to inter prediction. Here, CPMV is a vector representing the affine motion model of one of the upper left, upper right, and lower left of the current block.

The subtractor 113 may generate a residual block by using a difference between an input block and a prediction block. The residual block may be called a residual signal. The residual signal may mean a difference between an original signal and a prediction signal. Alternatively, the residual signal may be a signal generated by transforming or quantizing, or transforming and quantizing a difference between the original signal and the prediction signal. The residual block may be a residual signal of a block unit.

The transform unit 130 may generate a transform coefficient by performing transform on a residual block, and output the generated transform coefficient. Herein, the transform coefficient may be a coefficient value generated by performing transform on the residual block. When a transform skip mode is applied, the transform unit 130 may skip transform of the residual block.

A quantized level may be generated by applying quantization to the transform coefficient or to the residual signal. Hereinafter, the quantized level may also be called a transform coefficient in embodiments.

For example, a 4×4 luma residual block generated through intra prediction is transformed using a base vector based on DST (Discrete Sine Transform), and transform may be performed on the remaining residual block using a base vector based on DCT (Discrete Cosine Transform). In addition, a transform block is partitioned into a quad tree shape for one block using RQT (Residual Quad Tree) technology, and after performing transform and quantization on each transformed block partitioned through ROT, a coded block flag (cbf) may be transmitted to increase encoding efficiency when all coefficients become 0.

As another alternative, the Multiple Transform Selection (MTS) technique, which selectively uses multiple transform bases to perform transform, may be applied. That is, instead of partitioning a CU into TUs through ROT, a function similar to TU partition may be performed through the sub-block Transform (SBT) technique. Specifically, SBT is applied only to inter prediction blocks, and unlike ROT, the current block may be partitioned into 12 or 14 sizes in the vertical or horizontal direction and then transform may be performed on only one of the blocks. For example, if it is partitioned vertically, transform may be performed on the leftmost or rightmost block, and if it is partitioned horizontally, transform may be performed on the topmost or bottommost block.

In addition, LFNST (LOW Frequency Non-Separable Transform), a secondary transform technique that additionally transforms the residual signal transformed into the frequency domain through DCT or DST, may be applied. LENST additionally performs transform on the low-frequency region of 4×4 or 8×8 in the upper left, so that the residual coefficients may be concentrated in the upper left.

The quantization unit 140 may generate a quantized level by quantizing the transform coefficient or the residual signal according to a quantization parameter (QP), and output the generated quantized level. Herein, the quantization unit 140 may quantize the transform coefficient by using a quantization matrix.

For example, a quantizer using QP values of 0 to 51 may be used. Alternatively, if the image size is larger and high encoding efficiency is required, the QP of 0 to 63 may be used. Also, a DQ (Dependent Quantization) method using two quantizers instead of one quantizer may be applied. DQ performs quantization using two quantizers (e.g., Q0 and Q1), but even without signaling information about the use of a specific quantizer, the quantizer to be used for the next transform coefficient may be selected based on the current state through a state transition model.

The entropy encoding unit 150 may generate a bitstream by performing entropy encoding according to a probability distribution on values calculated by the quantization unit 140 or on coding parameter values calculated when performing encoding, and output the bitstream. The entropy encoding unit 150 may perform entropy encoding of information on a sample of an image and information for decoding an image. For example, the information for decoding the image may include a syntax element.

When entropy encoding is applied, symbols are represented so that a smaller number of bits are assigned to a symbol having a high occurrence probability and a larger number of bits are assigned to a symbol having a low occurrence probability, and thus, the size of bit stream for symbols to be encoded may be decreased. The entropy encoding unit 150 may use an encoding method, such as exponential Golomb, context-adaptive variable length coding (CAVLC), context-adaptive binary arithmetic coding (CABAC), etc., for entropy encoding. For example, the entropy encoding unit 150 may perform entropy encoding by using a variable length coding/code (VLC) table. In addition, the entropy encoding unit 150 may derive a binarization method of a target symbol and a probability model of a target symbol/bin, and perform arithmetic coding by using the derived binarization method, and a context model.

In relation to this, when applying CABAC, in order to reduce the size of the probability table stored in the decoding apparatus, a table probability update method may be changed to a table update method using a simple equation and applied. In addition, two different probability models may be used to obtain more accurate symbol probability values.

In order to encode a transform coefficient level (quantized level), the entropy encoding unit 150 may change a two-dimensional block form coefficient into a one-dimensional vector form through a transform coefficient scanning method.

A coding parameter may include information (flag, index, etc.) encoded in the encoding apparatus 100 and signaled to the decoding apparatus 200, such as syntax element, and information derived in the encoding or decoding process, and may mean information required when encoding or decoding an image.

Herein, signaling the flag or index may mean that a corresponding flag or index is entropy encoded and included in a bitstream in an encoder, and may mean that the corresponding flag or index is entropy decoded from a bitstream in a decoder.

The encoded current image may be used as a reference image for another image to be processed later. Therefore, the encoding apparatus 100 may reconstruct or decode the encoded current image again and store the reconstructed or decoded image as a reference image in the reference picture buffer 190.

A quantized level may be dequantized in the dequantization unit 160, or may be inversely transformed in the inverse transform unit 170. A dequantized and/or inversely transformed coefficient may be added with a prediction block through the adder 117. Herein, the dequantized and/or inversely transformed coefficient may mean a coefficient on which at least one of dequantization and inverse transform is performed, and may mean a reconstructed residual block. The dequantization unit 160 and the inverse transform unit 170 may be performed as an inverse process of the quantization unit 140 and the transform unit 130.

The reconstructed block may pass through the filter unit 180. The filter unit 180 may apply a deblocking filter, a sample adaptive offset (SAO), an adaptive loop filter (ALF), a bilateral filter (BIF), luma mapping with chroma scaling (LMCS), etc. to a reconstructed sample, a reconstructed block or a reconstructed image using all or some filtering techniques. The filter unit 180 may be called an in-loop filter. In this case, the in-loop filter is also used as name excluding LMCS.

The deblocking filter may remove block distortion generated in boundaries between blocks. In order to determine whether or not to apply a deblocking filter, whether or not to apply a deblocking filter to a current block may be determined based on samples included in several rows or columns which are included in the block. When a deblocking filter is applied to a block, a different filter may be applied according to a required deblocking filtering strength.

In order to compensate for encoding error using sample adaptive offset, a proper offset value may be added to a sample value. The sample adaptive offset may correct an offset of a deblocked image from an original image by a sample unit. A method of partitioning a sample included in an image into a predetermined number of regions, determining a region to which an offset is applied, and applying the offset to the determined region, or a method of applying an offset in consideration of edge information on each sample may be used.

A bilateral filter (BIF) may also correct the offset from the original image on a sample-by-sample basis for the image on which deblocking has been performed.

The adaptive loop filter may perform filtering based on a comparison result of the reconstructed image and the original image. Samples included in an image may be partitioned into predetermined groups, a filter to be applied to each group may be determined, and differential filtering may be performed for each group. Information of whether or not to apply the ALF may be signaled by coding units (CUs), and a form and coefficient of the adaptive loop filter to be applied to each block may vary.

In LMCS (Luma Mapping with Chroma Scaling), luma mapping (LM) means remapping luma values through a piece-wise linear model, and chroma scaling (CS) means a technique for scaling the residual value of the chroma component according to the average luma value of the prediction signal. In particular, LMCS may be utilized as an HDR correction technique that reflects the characteristics of HDR (High Dynamic Range) images.

The reconstructed block or the reconstructed image having passed through the filter unit 180 may be stored in the reference picture buffer 190. A reconstructed block that has passed through the filter unit 180 may be a part of a reference image. That is, the reference image is a reconstructed image composed of reconstructed blocks that have passed through the filter unit 180. The stored reference image may be used later in inter prediction or motion compensation.

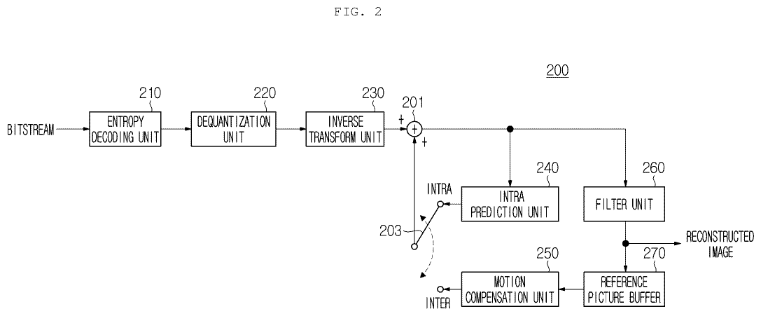

FIG. 2 is a block diagram showing a configuration of a decoding apparatus according to an embodiment of the present invention.

A decoding apparatus 200 may a decoder, a video decoding apparatus, or an image decoding apparatus.

Referring to FIG. 2, the decoding apparatus 200 may include an entropy decoding unit 210, a dequantization unit 220, an inverse transform unit 230, an intra prediction unit 240, a motion compensation unit 250, an adder 201, a switch 203, a filter unit 260, and a reference picture buffer 270.

The decoding apparatus 200 may receive a bitstream output from the encoding apparatus 100. The decoding apparatus 200 may receive a bitstream stored in a computer-readable recording medium, or may receive a bitstream that is streamed through a wired/wireless transmission medium. The decoding apparatus 200 may decode the bitstream in an intra mode or an inter mode. In addition, the decoding apparatus 200 may generate a reconstructed image generated through decoding or a decoded image, and output the reconstructed image or decoded image.

When a prediction mode used for decoding is an intra mode, the switch 203 may be switched to intra. Alternatively, when a prediction mode used for decoding is an inter mode, the switch 203 may be switched to inter.

The decoding apparatus 200 may obtain a reconstructed residual block by decoding the input bitstream, and generate a prediction block. When the reconstructed residual block and the prediction block are obtained, the decoding apparatus 200 may generate a reconstructed block that becomes a decoding target by adding the reconstructed residual block and the prediction block. The decoding target block may be called a current block.

The entropy decoding unit 210 may generate symbols by entropy decoding the bitstream according to a probability distribution. The generated symbols may include a symbol of a quantized level form. Herein, an entropy decoding method may be an inverse process of the entropy encoding method described above.

The entropy decoding unit 210 may change a one-dimensional vector-shaped coefficient into a two-dimensional block-shaped coefficient through a transform coefficient scanning method to decode a transform coefficient level (quantized level).

A quantized level may be dequantized in the dequantization unit 220, or inversely transformed in the inverse transform unit 230. The quantized level may be a result of dequantization and/or inverse transform, and may be generated as a reconstructed residual block. Herein, the dequantization unit 220 may apply a quantization matrix to the quantized level. The dequantization unit 220 and the inverse transform unit 230 applied to the decoding apparatus may apply the same technology as the dequantization unit 160 and inverse transform unit 170 applied to the aforementioned encoding apparatus.

When an intra mode is used, the intra prediction unit 240 may generate a prediction block by performing, on the current block, spatial prediction that uses a sample value of a block which has been already decoded around a decoding target block. The intra prediction unit 240 applied to the decoding apparatus may apply the same technology as the intra prediction unit 120 applied to the aforementioned encoding apparatus.

When an inter mode is used, the motion compensation unit 250 may generate a prediction block by performing, on the current block, motion compensation that uses a motion vector and a reference image stored in the reference picture buffer 270. The motion compensation unit 250 may generate a prediction block by applying an interpolation filter to a partial region within a reference image when the value of the motion vector is not an integer value. In order to perform motion compensation, it may be determined whether the motion compensation method of the prediction unit included in the corresponding coding unit is a skip mode, a merge mode, an AMVP mode, or a current picture reference mode based on the coding unit, and motion compensation may be performed according to each mode. The motion compensation unit 250 applied to the decoding apparatus may apply the same technology as the motion compensation unit 122 applied to the encoding apparatus described above.

The adder 201 may generate a reconstructed block by adding the reconstructed residual block and the prediction block. The filter unit 260 may apply at least one of inverse-LMCS, a deblocking filter, a sample adaptive offset, and an adaptive loop filter to the reconstructed block or reconstructed image. The filter unit 260 applied to the decoding apparatus may apply the same filtering technology as that applied to the filter unit 180 applied to the aforementioned encoding apparatus.

The filter unit 260 may output the reconstructed image. The reconstructed block or reconstructed image may be stored in the reference picture buffer 270 and used for inter prediction. A reconstructed block that has passed through the filter unit 260 may be a part of a reference image. That is, a reference image may be a reconstructed image composed of reconstructed blocks that have passed through the filter unit 260. The stored reference image may be used later in inter prediction or motion compensation.

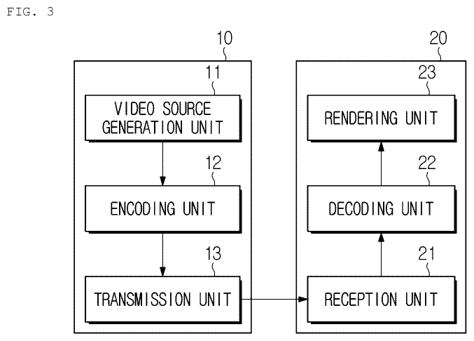

FIG. 3 is a diagram schematically showing a video coding system to which the present invention is applicable.

A video coding system according to an embodiment may include an encoding apparatus 10 and a decoding apparatus 20. The encoding apparatus 10 may transmit encoded video and/or image information or data to the decoding apparatus 20 in the form of a file or streaming through a digital storage medium or a network.

The encoding apparatus 10 according to an embodiment may include a video source generation unit 11, an encoding unit 12, and a transmission unit 13. The decoding apparatus 20 according to an embodiment may include a reception unit 21, a decoding unit 22, and a rendering unit 23. The encoding unit 12 may be called a video/image encoding unit, and the decoding unit 22 may be called a video/image decoding unit. The transmission unit 13 may be included in the encoding unit 12. The reception unit 21 may be included in the decoding unit 22. The rendering unit 23 may include a display unit, and the display unit may be configured as a separate device or an external component.

The video source generation unit 11 may obtain the video/image through a process of capturing, synthesizing, or generating the video/image. The video source generation unit 11 may include a video/image capture device and/or a video/image generation device. The video/image capture device may include, for example, one or more cameras, a video/image archive including previously captured video/image, etc. The video/image generation device may include, for example, a computer, a tablet, and a smartphone, etc., and may (electronically) generate the video/image. For example, a virtual video/image may be generated through a computer, etc., in which case the video/image capture process may be replaced with a process of generating related data.

The encoding unit 12 may encode the input video/image. The encoding unit 12 may perform a series of procedures such as prediction, transform, and quantization for compression and encoding efficiency. The encoding unit 12 may output encoded data (encoded video/image information) in the form of a bitstream. The detailed configuration of the encoding unit 12 may also be configured in the same manner as the encoding apparatus 100 of FIG. 1 described above.

The transmission unit 13 may transmit encoded video/image information or data output in the form of a bitstream to the reception unit 21 of the decoding apparatus 20 through a digital storage medium or a network in the form of a file or streaming. The digital storage medium may include various storage media such as USB, SD, CD, DVD, Blu-ray, HDD, SSD, etc. The transmission unit 13 may include an element for generating a media file through a predetermined file format and may include an element for transmission through a broadcasting/communication network. The reception unit 21 may extract/receive the bitstream from the storage medium or the network and transmit it to the decoding unit 22.

The decoding unit 22 may decode the video/image by performing a series of procedures such as dequantization, inverse transform, and prediction corresponding to the operation of the encoding unit 12. The detailed configuration of the decoding unit 22 may also be configured in the same manner as the above-described decoding apparatus 200 of FIG. 2.

The rendering unit 23 may render the decoded video/image. The rendered video/image may be displayed through the display unit.

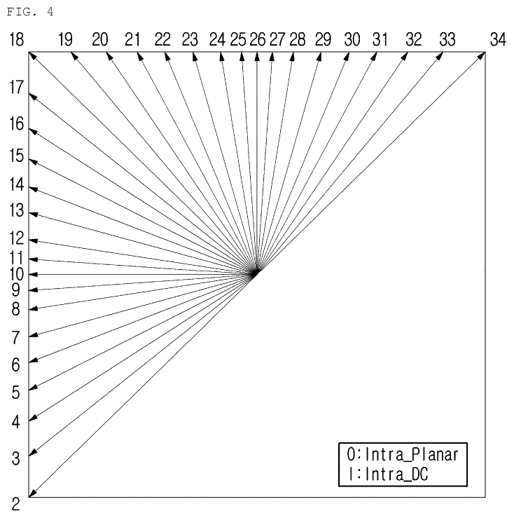

Hereinafter, with reference to FIGS. 4 to 15, a reference sample derivation method and an intra prediction method using the same according to an embodiment of the present invention will be described.

In the present invention, a reference sample may mean a reference pixel.

In addition, when a sample of a reconstructed area is used as a reference sample for intra prediction, it may be called a first reference sample or a reconstructed reference sample. Here, the first reference sample may mean a sample neighboring the left, top left, and top of the current block.

In addition, when a sample of an unreconstructed area is derived and used as a reference sample for intra prediction, it may be called a second reference sample or derived reference sample. Here, the second reference sample may mean a sample neighboring the right, bottom right, and bottom of the current block.

In addition, a reference sample including the first reference sample and the second reference sample may be called an omni-directional reference sample.

FIGS. 4 to 6 show examples of intra prediction modes used in a uni-directional intra prediction method using reference samples located at the top, top left, and left of a current block, i.e., first reference samples.

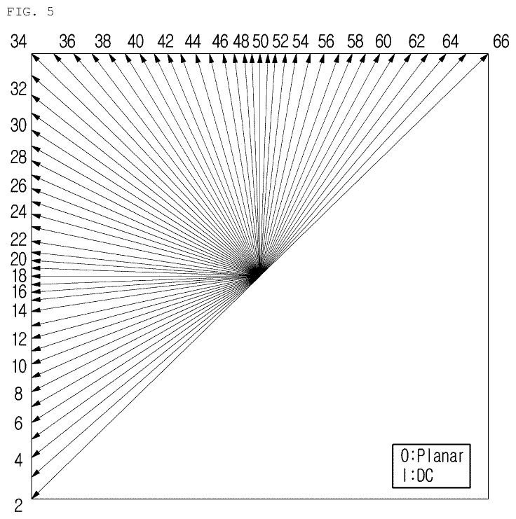

FIG. 4 shows a total of 35 intra prediction modes including a DC mode, a Planar mode, and 33 directional modes, and FIG. 5 shows a total of 67 intra prediction modes including a DC mode, a Planar mode, and 65 directional modes.

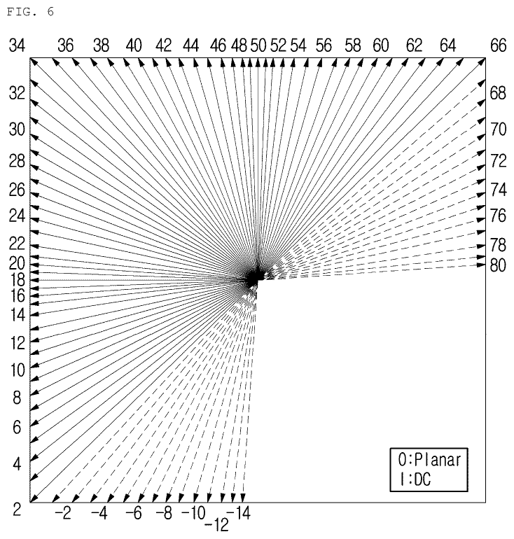

In addition, FIG. 6 shows a total of 95 intra prediction modes including a DC mode, a Planar mode, 65 directional modes, and 28 wide angular modes.

Intra prediction modes such as those in FIGS. 4 to 6 have a problem in that prediction accuracy decreases as the sample is farther away from the first reference sample, such as the sample in the bottom right area of the current block. In other words, prediction accuracy may decrease when intra prediction is used for samples in the bottom right area of the current block that are far from the left reference sample, the top reference sample, and the top left reference sample.

To solve this problem of uni-directional intra prediction, position dependent prediction combination (PDPC) and intra sub-partitions (ISP) were proposed.

Position dependent prediction combination can solve the problem of intra prediction described above by correcting the prediction value with a difference value between reference samples by using a combination of weight values of filtered and unfiltered reference samples according to the sample position, intra prediction mode, and block size.

Sub-partitioning can solve the problem of intra prediction described above by dividing a coding block into two or four partition areas in the vertical or horizontal direction according to the size of the coding block and performing prediction in the same intra prediction mode for each partition area.

However, both of these methods do not solve the fundamental problem of intra prediction that generates a prediction block using an intra prediction mode based on the first reference sample, so the prediction accuracy may still decrease for samples far from the reference sample, which is the problem of intra prediction.

Therefore, in order to solve the above-described problem, a method of deriving a second reference sample used for intra prediction will be described in detail below.

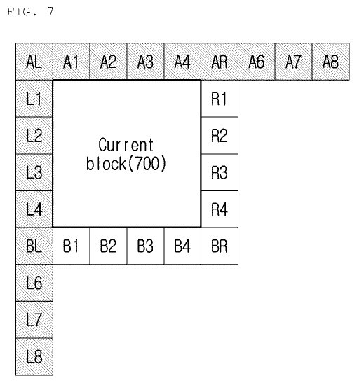

FIG. 7 is a diagram for explaining an omni-directional reference sample for intra prediction according to an embodiment of the present invention.

The first reference sample may mean a reference sample located on the left, top, or top left with respect to a current block 700. In addition, the second reference sample may mean a reference sample located on the right, bottom, or bottom right with respect to the current block 700.

Referring to FIG. 7, the first reference sample may refer to a reference sample located in any one of the left reference samples L1, L2, L3, L4, BL, L6, L7 and L8, the top reference samples A1, A2, A3, A4, AR, A6, A7 and A8, and the top left reference sample AL located at the top left. In addition, the second reference sample may refer to a reference sample located in any one of the right reference samples R1, R2, R3 and R4, the bottom reference samples B1, B2, B3 and B4, and the bottom right reference sample BR.

The above-described first reference sample or second reference sample may be a sample area including a plurality of samples, or may be a reference sample composed of one sample.

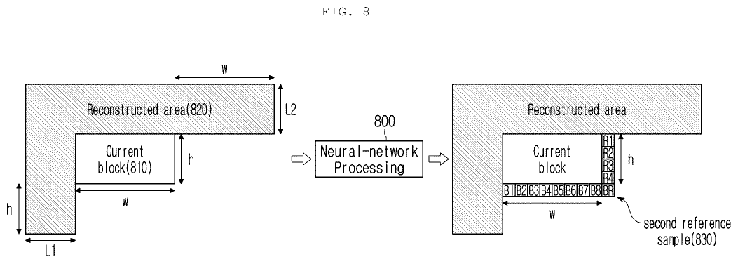

FIG. 8 is a diagram for explaining a neural network-based reference sample derivation method according to an embodiment of the present invention.

Referring to FIG. 8, an encoder/decoder may input samples of a reconstructed area 820 around a current block 810 to a neural network processing unit 800 to derive second reference samples 830 of an unreconstructed area, i.e., bottom reference samples B1 to B8, right reference samples R1 to R4, and a bottom right reference sample BR.

Meanwhile, the size of the reconstructed samples around the current block, which are inputs to the neural network processing unit, may be determined based on signaling information. For example, the size of the reconstructed samples used as inputs to the neural network processing unit may be (L1×a×h)+(b×w×L2)+(L1×L2). Here, w and h represent the width and height of the current block, and the values of a, b, L1, and L2 may be determined by the encoder and transmitted to the decoder. Additionally, a, b, L1 and L2 may be set to predetermined values in the encoder/decoder.

If the values of a and b are 1, the size of the reconstructed samples used as inputs to the neural network processing unit may be (L1×h)+ (w×L2)+ (L1×L2).

Meanwhile, the size of the reconstructed samples around the current block, which is the inputs to the neural network processing unit, may be a fixed size that is determined in advance.

The neural network processing unit may be implemented as a neural network model. Here, the artificial neural network model may represent a deep neural network including one or more neural network layers. In addition, the neural network model may include all or some of a convolution layer, a fully-connected layer, and a pooling layer. The neural network model may be implemented in a form including one type of neural network layer, or may be implemented in a form in which different types of layers are additionally combined.

Meanwhile, initial internal parameters of the neural network model used in the neural network processing unit are pre-learned, but may be additionally learned during the encoding/decoding process.

As described above, in addition to the reconstructed reference samples around the current block, the coding information of the current block or neighboring blocks (for example, intra prediction mode, syntax element information, etc.) may be used together as inputs to the neural network model for generating the second reference samples.

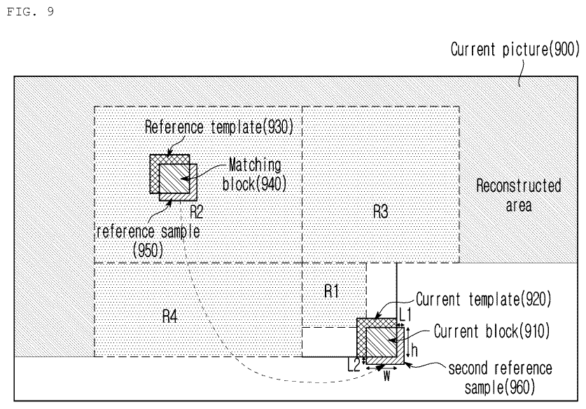

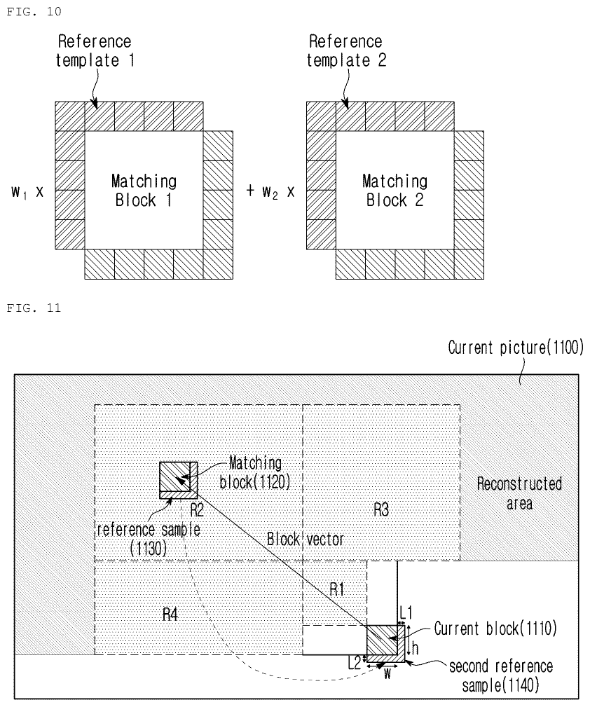

FIGS. 9 to 10 are diagrams for explaining a template matching-based reference sample derivation method according to an embodiment of the present invention.

An Intra Template Matching Prediction (Intra TMP) method means a method of searching for an optimal prediction block in a reconstructed area of a current picture using template matching and copying it to generate a prediction block of a current block. The method of deriving the reference sample based on template matching described in FIGS. 9 and 10 may derive neighboring reference samples of the current block from the reconstructed area similarly to the above-described template matching-based intra prediction method.

Referring to FIG. 9, the neighboring-area (i.e., the left, top, and top left area) of a current block 910 may be defined as a current template 920. Then, a reference template 930 most similar to the current template 920 may be searched within predefined search ranges R1, R2, R3 and R4 of the reconstructed area of a current picture 900. Then, a second reference sample 960 of an unreconstructed area of the current block 910 may be derived based on a reference sample 950 including a bottom sample, a right sample, and a bottom right sample neighboring a corresponding matching block 940 of the determined reference template 930.

The predefined search ranges R1, R2, R3, and R4 in FIG. 9 may be defined as the current CTU (Coding Tree Unit) including the current block, the top left CTU, the top CTU, and the left CTU, respectively.

In addition, in the predefined search ranges, a reference template may be searched based on the predefined search order. For example, the reference template may be searched in the zigzag order of R1, R4, R3, R2.

Meanwhile, information about the search range and the size and shape of the current template may be determined by the encoder and transmitted to the decoder. In addition, the search range and the size and shape of the current template may be set to values predefined in the encoder/decoder.

For example, instead of a r-shaped template that uses both the left reconstructed area and the top reconstructed area, only the top reconstructed area or the left reconstructed area may be used as a template.

Meanwhile, information about the size of the second reference sample may be determined by the encoder and transmitted to the decoder. In addition, the size of the second reference sample may be set to a value predetermined by the encoder/decoder.

For example, the size of the second reference sample may be determined to be (w×L2)+(L1×h)+(L1×L2) as in FIG. 9. In this case, w and h represent the width and height of the current block, and the values of L1 and L2 may be determined to be any positive integers.

With respect to the template shape, in the example of FIG. 9, r-shaped template is used to search for the reference template most similar to the current template, but this is an example, and an L-shaped template, a template using only the top area, a template using only the left area, or a template having any shape may be used to search for the reference template most similar to the current template.

With respect to the number of templates, in the example of FIG. 9, a method of deriving the second reference sample using one template is described, but this is an example, and a final second reference sample may be derived by a weighted sum of N second reference samples derived from N (where N≥2 is an integer) templates.

FIG. 10 shows a method of deriving a final second reference sample using two templates.

Referring to FIG. 10, matching block 1 and matching block 2 corresponding to the current block are searched based on template matching. The final second reference sample of the current block may be determined by a weighted sum of the neighboring reference samples of the two matching blocks. At this time, 0≤w1≤1, 0≤w2≤1, and the value of w1+w2=1 may be obtained.

Here, matching block 1 and matching block 2 may be matching blocks searched in different search ranges, respectively. For example, matching block 1 and matching block 2 may be matching blocks searched in R1 and R2 of FIG. 9, respectively.

In addition, matching block 1 and matching block 2 may be matching blocks searched by different template shapes. For example, matching block 1 and matching block 2 may be matching blocks searched by a template using only the upper area and a template using only the left area.

The template matching-based reference sample derivation method proposed in FIGS. 9 and 10 may perform the same template matching process as the encoder in the decoder without signaling (transmitting/parsing) the syntax related to the reference sample derivation, thereby deriving the reference sample.

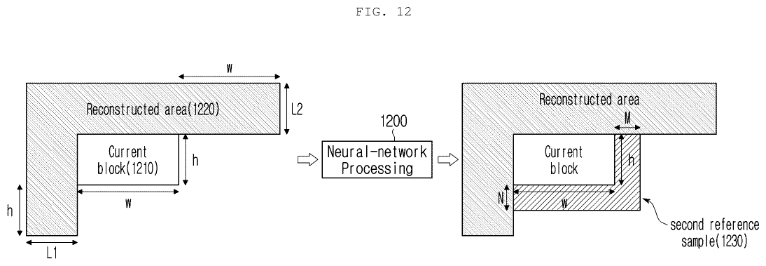

FIG. 11 is a diagram for explaining a motion information-based reference sample derivation method according to an embodiment of the present invention.

In the motion information-based reference sample derivation method described in FIG. 11, unlike the template matching-based reference sample derivation method described above, a reference sample is derived by transmitting/parsing syntax related to motion information.

Referring to FIG. 11, a matching block 1120 may be derived within predefined search ranges R1, R2, R3 and R4 of a reconstructed area of a current picture 1100 based on motion information (block vector) of a current block 1110. In addition, a second reference sample 1140 of an unreconstructed area of the current block 1110 may be derived based on a reference sample 1130 of the matching block 1120.

Although it is explained that matching blocks are derived within the search range defined in FIG. 11, matching blocks may be derived based on motion information in the reconstructed area within the current picture.

Meanwhile, motion information for deriving reference samples may be determined by the encoder and transmitted to the decoder.

Meanwhile, in FIGS. 7 to 11, the second reference sample for intra prediction is described as one sample line, but is not limited thereto, and the reference sample may be determined from at least one sample line among a plurality of sample lines. That is, reference samples of a plurality of reference sample lines may be derived according to the reference sample derivation method according to FIGS. 8 to 11.

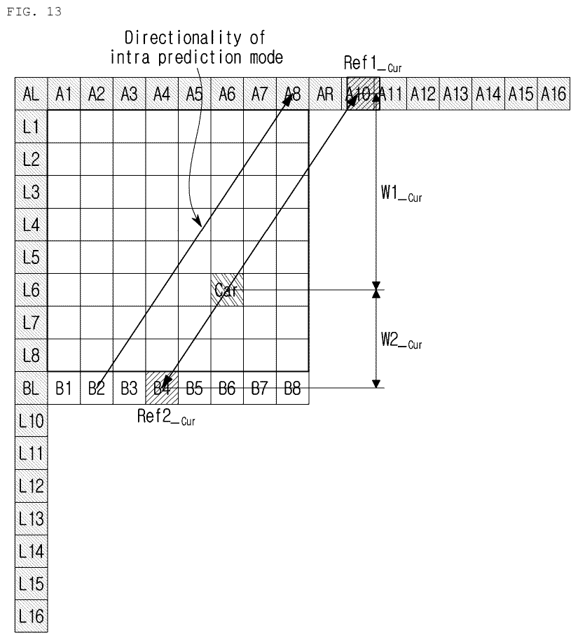

FIG. 12 is a diagram for explaining a plurality of reference sample lines derived using a neural network-based reference sample derivation method according to an embodiment of the present invention.

Referring to FIG. 12, the encoder/decoder may input a sample of a reconstructed area 1220 around a current block 1210 into a neural network processing unit 1200 to derive a second reference sample 1230 including a plurality of reference sample lines. Here, the size of the second reference sample is (w×N)+(M×h)+(M×N), and M and N are any positive integers.

Meanwhile, the plurality of reference sample lines may be identified by an index. For example, the index (0 to n, n is a positive integer) may be set in the order adjacent to the current block.

Hereinafter, an intra prediction method using a second reference sample derived by the above-described reference sample derivation method and a first reference sample of a reconstructed area will be described. Here, a reference sample including the first reference sample and the second reference sample may be referred to as an omni-directional reference sample.

FIG. 13 is a diagram for explaining bi-directional intra prediction using omni-directional reference samples according to an embodiment of the present invention.

In bi-directional intra prediction using an omni-directional reference sample according to an embodiment of the present invention, after deriving a second reference sample, a first prediction sample may be generated from a first reference sample based on the directionality of an intra prediction mode, a second prediction sample may be generated from the second reference sample corresponding to the first reference sample, and a final prediction sample may be generated by a weighted sum of the generated first prediction sample and second prediction sample. At this time, since the second reference sample is present at a position corresponding to the first reference sample, the problem of a uni-directional intra prediction using only the first reference sample, in which the prediction accuracy of a current sample far from the first reference sample is low, can be solved by using the second reference sample corresponding to the first reference sample.

In FIGS. 13, A1 to A16, L1 to L16 and AL represent top reference samples, left reference samples and a top left reference sample, respectively, as the first reference sample. In addition, Cur represents a current sample to be predicted, and Ref1_{_Cur} and Ref2_{_Cur} represent a first reference sample and a second reference sample corresponding to the current sample Cur to be predicted, respectively, based on the directionality of the current intra prediction mode. In addition W1_{_Cur} and W2_{_Cur} represent a weight value of the first reference sample and a weight value of the second reference sample, respectively. In FIG. 13, the directionality of the intra prediction mode is a vertical directional mode, and B1 to B8 represent second reference samples corresponding to the vertical directional mode.

If uni-directional intra prediction is performed using the intra prediction mode of FIG. 13, the prediction value of the current sample Cur uses the value of the first reference sample Ref1_{_Cur} without change. At this time, a distance between the current sample Cur and the first reference sample Ref1_{_Cur} may be large, thereby decreasing prediction accuracy.

In the bi-directional intra prediction shown in FIG. 13, a final prediction sample may be generated by using the first reference sample Ref1_{_Cur} determined based on the directionality of the intra prediction mode and the second reference sample Ref2_{_Cur} corresponding to the first reference sample to solve the problem of uni-directional intra prediction.

$$Cur\_Pred = W 1 {\_}_{Cur} \times {Ref1\_}_{Cur} + W 2 {\_}_{Cur} \times Ref 2 {\_}_{Cur} \qquad [ Equation 1 ]$$

Equation 1 represents an equation that generates a final prediction value of a current sample by a weighted sum of the first reference sample and the second reference sample corresponding to the first reference sample.

In Equation 1, the prediction value Cur Pred of the current sample Cur may be generated by a weighted sum of the value of the first reference sample Ref1_{_Cur} and the value of the second reference sample Ref2_{_Cur} corresponding to the first reference sample. At this time, the weight values of the two reference samples may be determined to be a ratio of the distance between the current sample and each reference sample, as in FIG. 13, or may use a predetermined arbitrary weight value.

The weight value W1_{_Cur} of the first reference sample and the weight value W2_{_Cur} of the second reference sample may be values between 0 and 1, respectively, and W1_{_Cur}+W2_{_Cur}=1.

FIG. 13 illustrates an example in which the intra prediction mode is a vertical directional mode using the top reference sample, but even in a case in which the intra prediction mode is a horizontal directional mode using the left reference sample or a wide angular mode, the prediction block may be generated using the same method as the bi-directional intra prediction method described in FIG. 13.

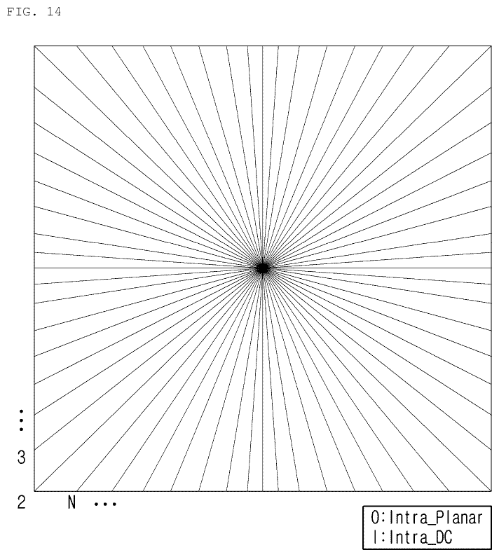

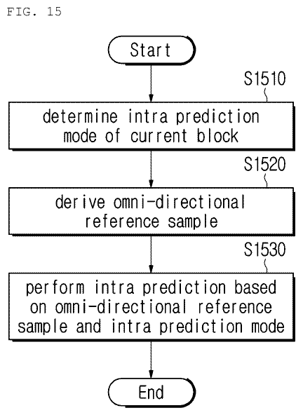

FIG. 14 is a diagram for explaining uni-directional intra prediction using omni-directional reference samples according to an embodiment of the present invention.

Specifically, FIG. 14 shows an intra prediction mode that extends the directionality of the intra prediction mode by considering omni-directional reference samples. By using omni-directional reference samples, the directionality of the intra prediction mode may be extended to the right, bottom, and bottom-right directions where the directionality of the intra prediction mode is not present as in FIGS. 4 to 6. That is, the extended intra prediction mode as shown in FIG. 14 may define the intra prediction mode not only in the left, top, and top-left directions, but also in the right, bottom, and bottom-right directions.

FIG. 14 shows an example of extending N+1 (Planar mode, DC mode, mode 2, . . . , mode N) intra prediction modes omnidirectionally. Here, N is any positive integer. For example, if the omni-directional intra prediction mode proposed in FIG. 14 is applied to 35 intra prediction modes of FIG. 4, N may be 65. If the omni-directional intra prediction mode proposed in FIG. 14 is applied to 67 intra prediction modes of FIG. 5, N may be 129.

The intra prediction mode proposed in FIG. 14 extends the directionality of the intra prediction mode according to the unequal angle, but this is an example and may extend the directionality of the intra prediction mode according to the equal angle as an example.

In the uni-directional intra prediction using the omni-directional reference sample according to an embodiment of the present invention, a prediction block may be generated by copying not only the first reference sample but also the second reference sample according to the directionality of the intra prediction mode of FIG. 14.

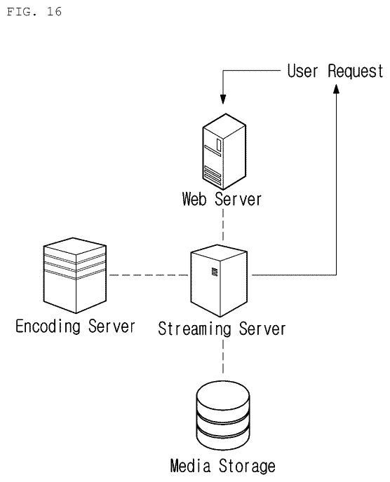

FIG. 15 is a flowchart illustrating an image decoding method according to an embodiment of the present invention.

The image decoding method of FIG. 15 may be performed by an image decoding apparatus.

The image decoding apparatus may determine an intra prediction mode of a current block (S1510). Here, the intra prediction mode may be determined to be one of a planar mode, a DC mode, and an angular mode.

Meanwhile, the intra prediction mode may include an omnidirectionally extended directional mode. The omnidirectionally extended directional mode was described in detail in FIG. 14.

In addition, the image decoding apparatus may derive an omni-directional reference sample (S1520). Here, the omni-directional reference sample may include a first reference sample located at any one of the top, left, and top left of the current block and a second reference sample located at any one of the bottom, right, and bottom right of the current block. An embodiment of the first reference sample and the second reference sample of the omni-directional reference sample was described in detail in FIG. 7.

Meanwhile, the first reference sample may be derived from a reconstructed area.

In addition, the second reference sample may be derived based on the neighboring samples of a matching block searched by performing template matching. In addition, the second reference sample may be derived based on the weighted sum of the neighboring samples of a plurality of matching blocks searched by performing multiple template matching.

Meanwhile, the second reference sample may be derived based on the neighboring samples of the matching block in the current picture indicated by the motion information of the current block.

Meanwhile, the second reference sample may be derived based on a neural network model that receives the sample of the reconstructed area neighboring the current block as input.

The method of deriving the second reference sample was described in detail in FIGS. 8 to 12.

Then, the image decoding apparatus may perform intra prediction based on the omni-directional reference sample and the intra prediction mode (S1530).

Meanwhile, the step of performing intra prediction may be performed by a weighted sum of a first prediction sample generated using a first reference sample according to an intra prediction mode and a second prediction sample generated using a second reference sample corresponding to the first reference sample. The bi-directional intra prediction using the above-mentioned omni-directional reference sample was described in detail in FIG. 13.

Meanwhile, the steps described in FIG. 15 may be performed in the same manner in an image encoding method. In addition, a bitstream may be generated by an image encoding method including the steps described in FIG. 15. The bitstream may be stored in a non-transitory computer-readable recording medium, and may also be transmitted (or streamed).

FIG. 16 exemplary illustrates a content streaming system to which an embodiment according to the present invention is applicable.

As illustrated in FIG. 11, a content streaming system to which an embodiment of the present invention is applied may largely include an encoding server, a streaming server, a web server, a media storage, a user device, and a multimedia input device.

The encoding server compresses content received from multimedia input devices such as smartphones, cameras, CCTVs, etc. into digital data to generate a bitstream and transmits it to the streaming server. As another example, if multimedia input devices such as smartphones, cameras, CCTVs, etc. directly generate a bitstream, the encoding server may be omitted.

The bitstream may be generated by an image encoding method and/or an image encoding apparatus to which an embodiment of the present invention is applied, and the streaming server may temporarily store the bitstream in the process of transmitting or receiving the bitstream.

The streaming server transmits multimedia data to a user device based on a user request via a web server, and the web server may act as an intermediary that informs the user of any available services. When a user requests a desired service from the web server, the web server transmits it to the streaming server, and the streaming server may transmit multimedia data to the user. At this time, the content streaming system may include a separate control server, and in this case, the control server may control commands/responses between devices within the content streaming system.

The streaming server may receive content from media storage and/or an encoding server. For example, when receiving content from the encoding server, the content may be received in real time. In this case, in order to provide a smooth streaming service, the streaming server may store the bitstream for a certain period of time.

Examples of the user devices may include mobile phones, smartphones, laptop computers, digital broadcasting terminals, personal digital assistants (PDAs), portable multimedia players (PMPs), navigation devices, slate PCs, tablet PCS, ultrabooks, wearable devices (e.g., smartwatches, smart glasses, HMDs), digital TVs, desktop computers, digital signage, etc.

Each server in the above content streaming system may be operated as a distributed server, in which case data received from each server may be distributed and processed.

The above embodiments may be performed in the same or corresponding manner in the encoding apparatus and the decoding apparatus. In addition, an image may be encoded/decoded using at least one or a combination of at least one of the above embodiments.

The order in which the above embodiments are applied may be different in the encoding apparatus and the decoding apparatus. Alternatively, the order in which the above embodiments are applied may be the same in the encoding apparatus and the decoding apparatus.

The above embodiments may be performed for each of the luma and chroma signals. Alternatively, the above embodiments for the luma and chroma signals may be performed identically.

In the above-described embodiments, the methods are described based on the flowcharts with a series of steps or units, but the present invention is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present invention.

The embodiments may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present invention, or well-known to a person of ordinary skill in the computer software technology field.

A bitstream generated by the encoding method according to the above embodiment may be stored in a non-transitory computer-readable recording medium. In addition, a bitstream stored in the non-transitory computer-readable recording medium may be decoded by the decoding method according to the above embodiment.

Examples of the computer-readable recording medium include magnetic recording media such as hard disks, floppy disks, and magnetic tapes; optical data storage media such as CD-ROMs or DVD-ROMs; magneto-optimum media such as floptical disks; and hardware devices, such as read-only memory (ROM), random access memory (RAM), flash memory, etc., which are particularly structured to store and implement the program instruction. Examples of the program instructions include not only a mechanical language code formatted by a compiler but also a high-level language code that may be implemented by a computer using an interpreter. The hardware devices may be configured to be operated by one or more software modules or vice versa to conduct the processes according to the present invention.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

### INDUSTRIAL APPLICABILITY

The present invention may be used in an apparatus for encoding/decoding an image and a recording medium for storing a bitstream.

1. An image decoding method comprising:
determining an intra prediction mode of a current block;
deriving an omni-directional reference sample; and
performing intra prediction based on the omni-directional reference sample and the intra prediction mode,
wherein the omni-directional reference sample includes a first reference sample located at any one of a top, left, and top left of the current block and a second reference sample located at any one of a bottom, right, and bottom right of the current block.

2. The image decoding method of claim 1, wherein the first reference sample is derived from a reconstructed area.

3. The image decoding method of claim 1, wherein the second reference sample is derived based on a neighboring sample of a matching block searched by performing template matching.

4. The image decoding method of claim 3, wherein the second reference sample is derived based on a weighted sum of neighboring blocks of a plurality of matching blocks searched by performing multiple template matching.

5. The image decoding method of claim 1, wherein the second reference sample is derived based on a neighboring sample of a matching block in a current picture indicated by motion information of the current block.

6. The image decoding method of claim 1, wherein the second reference sample is derived based on a neural network model that receives a sample of a reconstructed area neighboring the current block as input.

7. The image decoding method of claim 1, wherein the intra prediction mode includes an omnidirectionally extended directional mode.

8. The image decoding method of claim 1, wherein the intra prediction is performed by a weighted sum of a first prediction sample generated using the first reference sample according to the intra prediction mode and a second prediction sample generated using a second reference sample corresponding to the first reference sample.

9. An image encoding method comprising:
determining an intra prediction mode of a current block;
deriving an omni-directional reference sample; and
performing intra prediction based on the omni-directional reference sample and the intra prediction mode,
wherein the omni-directional reference sample includes a first reference sample located at any one of a top, left, and top left of the current block and a second reference sample located at any one of a bottom, right, and bottom right of the current block.

10. A non-transitory computer-readable recording medium for storing a bitstream generated by an image encoding method, the image encoding method comprising:
determining an intra prediction mode of a current block;
deriving an omni-directional reference sample; and
performing intra prediction based on the omni-directional reference sample and the intra prediction mode,
wherein the omni-directional reference sample includes a first reference sample located at any one of a top, left, and top left of the current block and a second reference sample located at any one of a bottom, right, and bottom right of the current block.

11. (canceled)
